(19) United States
(12) Patent Application Publication
(10) Pub. No.: US 2008/0185524 A1
(43) Pub. Date: Aug. 7, 2008

(54) Method and Sensor for Infrared Measurement of Gas

(75) Inventor: Svein Otto Kanstad, Volda (NO)

Correspondence Address: LADAS & PARRY LLP, 26 WEST 61ST STREET, NEW YORK, NY, 10023, US

(73) Assignee: KANSTAD TEKNOLOGI AS, Volda (NO)

(21) Appl. No.: 11/664,656

(22) PCT Filed: Oct. 7, 2004
(86) PCT No.: PCT/IB04/03438

§ 371 Date: Apr. 4, 2007

(51) Int. Cl. G01N 21/31; G01J 3/42

(52) U.S. Cl. 250/338.5; 250/345

(57) ABSTRACT

Method and sensor for infrared measurement of gas comprising one infrared radiation source which illuminates two detectors at different distances from the radiation source, a spectrally selective element for infrared radiation adapted to be absorbed in a gas a to be measured arranged between the IR source and each of the detectors, and another infrared radiation source that illuminates those same two detectors possibly via a spectrally selective element for infrared radiation which by preference is not absorbed by any present gas. The radiation sources are excited at different patterns in time, and an electronic unit is adapted to select and separately amplify the resulting signals at said patterns from the detectors and to use the mutual ratios between such signals to calculate the concentration of said gas a.

This invention concerns infrared (IR) sensors for gas, and discloses how, with simple, economical and existing technical means one may improve the performance and stability over time of such sensors. In addition, simultaneous measurements of several gases may easily be made. The invention will significantly enhance the usefulness of IR sensors for gas, thus enabling their employment in several applications and connections where such sensors may not be used today.

In principle, IR sensors for gas consist of an IR radiation source with electrical energizing means, a detector for IR radiation and optics to guide IR radiation from the IR source to the IR detector, a spectrally selective element for selection of IR radiation distinctive of a gas to be measured adapted between the IR source and the IR detector—alternatively made as an integral part of the IR source or the IR detector—, and an electronic system for treatment of electrical signals from the detector when illuminated by such spectral IR radiation. With a volume that contains or can be supplied with gas arranged between the IR source and the IR detector, some IR radiation from the source may be absorbed by the gas so that less IR radiation reaches the detector. From this one is able to establish a calibration curve or table, which for a certain path length L provides a unique expression for the transmission T(c) through the gas at concentration c.

However, other factors too may influence the signals released by the detector. In particular, these may include 1) variations in the spectral radiation intensity of the source, 2) changes in detector responsivity and 3) dust and dirt on optical surfaces. Unless such factors are compensated for, any undesirable signal variations will be interpreted either as random changes in gas density or as loss of calibration over time. The most commonly used method for such compensation is to perform a corresponding (reference) measurement of the transmission T(R) inside a neighbouring spectral interval not absorbed by any relevant gas. Circumstances permitting, the relation T(c)/T(R) then compensates for any factors whose influence on the reference signal approximates that on the gas measurement itself, as with dust and dirt. Such two-beam techniques with reference measurement are fundamental to most currently known IR sensors for gas.

Unfortunately, spectral reference measurements also introduce new problems. A separate detector for the reference radiation may often be required, so that as the two detectors may change differently over time, the relation between gas and reference signals will not be unambiguously given by the gas concentration. Alternatively, two IR sources may be employed to illuminate one single detector to measure both gas and reference signals; the two sources may then vary differently over time. This problem is quite characteristic of the prior art of IR gas measurement,—solution of one problem often leads to another.

This invention has as its main target to overcome those limitations in the prior art. Generally, for each single gas one can proceed as disclosed in claim 1, using two coupled IR sensors comprising two IR sources A and R and two IR detectors D1 and D2, with a spectrally selective element adapted to the absorption spectrum of a particular gas a to be measured arranged between IR source A and each detector. Optical means guide spectral IR radiation from IR source A onto the IR detectors across a path length L1a through the gas to detector D1 and across path length L2a through the gas to detector D2, where L1a is by preference materially larger than L2a. For the gas a, being dispersed at some unknown concentration c in a certain volume arranged between the IR sources and IR detectors and adapted to contain or receive gas, two independent spectral measurements may then be performed, one for each detector, with electrical signals S₁(a) and S₂(a) from detectors D1 and D2, respectively, which express the transmissions T₁ and T₂ of the selected spectral radiation across two different path lengths through the gas. Similarly, IR radiation is guided from the second IR source R to the IR detectors across suitable path lengths L3 and L4—which may equal or differ from each other and/or L1a and L2a, depending on what is practical in the actual application—, with corresponding signals S₁(R) and S₂(R) from the detectors. As disclosed in claim 3, the latter measurements may alternatively be made with a spectrally selective element for IR radiation that is only weakly—and preferably not—absorbed by any present gas arranged between IR source R and each detector. By exciting each IR source according to its own particular pattern in time—M(A) for IR source A and M(R) for IR source R—signals from the IR sources may for each detector be separated from each other by means of a suitable electronic unit. From this one may use the relation

F(a)=[(S₁(a)/S₂(a)]/[S₁(R)/S₂(R)] (1)

to determine the concentration c of the actual gas a.

With an additional IR source X which is excited according to its particular pattern M(X) in time and having two different path lengths L1x and L2x through the gas volume to the IR detectors D1 and D2 that may differ from L1a and L2a, comprising a spectrally selective element for another gas x adapted between IR source X and the detectors, and by means of detector signals on pattern M(X) and the former signals due to IR source R, one may in similar manner calculate the value of a corresponding function F(x) to determine the concentration of gas x. This approach may then be repeated for several gases to be detected by the sensor, thus in a simple manner to produce a multigas sensor for simultaneous measurement of two or more gases with the modest addition of a single IR source and corresponding spectrally selective elements for each separate gas. The path lengths for spectrally selected radiation from each single IR source through the gas volume to the detectors may then differ from gas to gas according to measuring conditions and the actual concentrations of each separate gas—lower concentrations require larger path lengths.

A more detailed description of the invention is given below, with reference to the figures whose shapes and size relations may be distorted for clarity of presentation and where

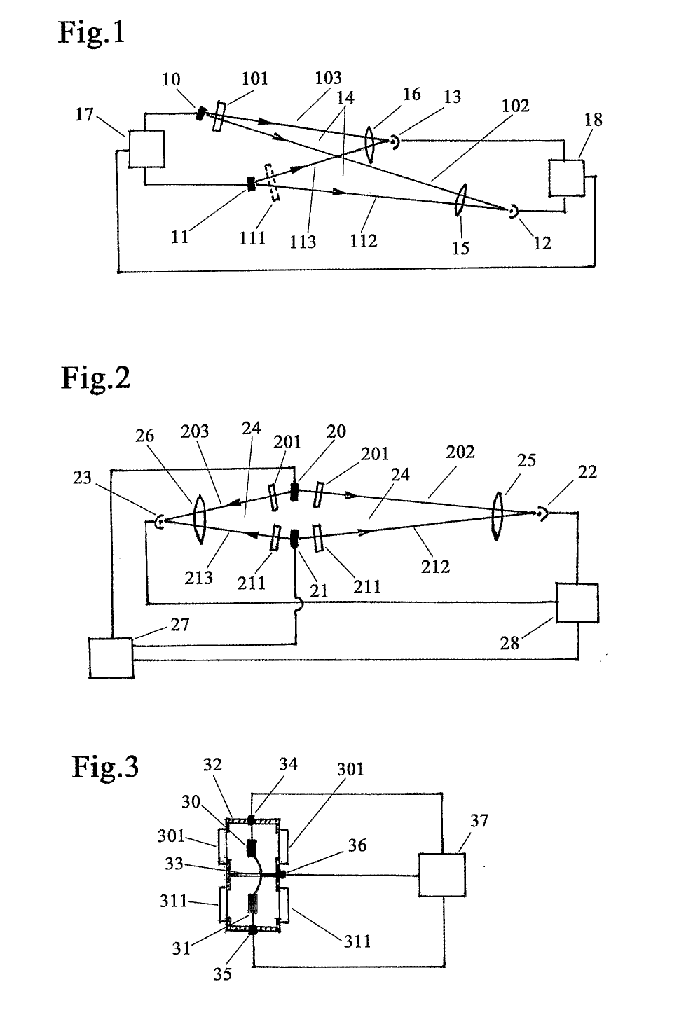

FIG. 1 shows schematically a general embodiment of the invention,

FIG. 2 shows schematically an embodiment of the invention in which the IR sources radiate from their front and rear surfaces and with the IR detectors situated at different distances one on either side of the IR sources,

FIG. 3 shows schematically a special unit comprising two IR sources mounted side by side with spectrally selective elements adapted on both sides of each IR source.

FIG. 1 depicts a sensor according to claim 2 for carrying out the method given in claim 1. As illustrated in FIG. 1, the sensor comprises an IR source 10 with optical path lengths 102 and 103, respectively, to IR detectors 12 and 13 through a volume 14 that is adapted to contain or receive gas. For simplicity and in order to illustrate the concept, the detectors are shown with different physical distances to the IR sources in the figure, however, the optical path lengths through the gas may be equal to or differ from the physical distances depending on the measuring conditions. Between IR source 10 and the detectors is shown a spectrally selective element 101 adapted to IR radiation suitable for a particular gas a to be measured. Another IR source 11 is arranged with path lengths 112 to detector 12 and 113 to detector 13. Infrared radiation is guided from the IR sources through the volume to the detectors using optical means 15 and 16,—for radiation from source 10 this takes place via the spectrally selective element 101. Electrical means 17 excite the IR sources at each source's particular pattern in time named M(A) for IR source 10 and M(R) for source 11. IR radiation incident on each detector, and electrical signals released by the latter, thus will consist of a sum of those two patterns. Signals from the detectors are received by electronic system 18, which is coordinated with excitation means 17 and is adapted to amplify and separate signals on the two patterns M(A) and M(R) from each detector. On the basis of those four different signals from the detectors one is able to calculate the value of the function F(a) given in relation (1) above, from which using a calibration curve or table a measure of the concentration c for the actual gas a can be established in suitable units.

Without a spectrally selective element between IR source 11 and the detectors, one has the option of having particularly strong radiation from that source onto the detectors. This may be advantageous in order to obtain as good signal-to-noise ratios as possible for the total measurement, especially when other signals are weak. Alternatively, a simpler or weaker IR source may be used for this function. On the other hand, the presence of varying amounts of different gases with absorption inside the transmitted spectral range from source 11 will be interpreted as randomly varying noise in the measurements, thus restricting the obtainable sensitivity and resolution. Therefore, as disclosed in claim 3 and indicated by a stipled element in FIG. 1, a spectrally selective element 111 for reference radiation that is not absorbed by any present gas may be adapted between IR source 11 and the detectors. At the cost of one additional spectrally selective element one then has a more general and robust sensor for multigas purposes in particular.

FIG. 2 shows an embodiment of a sensor as disclosed in claim 6, comprising IR source 20 radiating from its front and rear sides, IR detectors 22 and 23 adapted one on each side of the IR source with unequal path lengths 202 and 203 through the gas volume 24 to the IR source, and with a spectrally selective element 201 for a particular gas adapted on each side of the IR source between it and each detector. A second IR source 21 that also radiates from its front and rear sides is arranged between the same two detectors, with optical path lengths 212 and 213 to detectors 22 and 23, respectively. A spectrally selective element 211 for spectral reference purposes is adapted on each side of the IR source between it and the detectors. Optical means 25 and 26 adapted on each side of the IR sources guide IR radiation to the detectors through the volume 24, which is adapted to receive or contain gas to be measured. Excitation means 27 excite the IR sources at different patterns in time, and electronic system 28 separates the relevant electrical signals from the detectors and performs the operations that follow from claim 1 to find the concentration of that particular gas which corresponds with the spectrally selective elements 201. A configuration such as shown in FIG. 2 may provide certain advantages particularly for multigas measurements, at a cost of one additional spectrally selective element for each separate gas.

As disclosed in claim 4 one may for the IR sources use thermally glowing sources, for instance conventional incandescent lamps which could, however, have some limited uses when encapsulated in glass bulbs. A preferred design of the IR sources would be radiation-cooled thermal sources as disclosed in U.S. Pat. Nos. 5,220,173 and 6,540,690 B1, which are particularly suited to produce strong radiation pulses either singly or in controlled pulse trains at rather high pulse frequencies; such sources may be made arbitrarily large without loss of time response. The invention could also apply lasers or light emitting diodes with infrared emission, possibly other kinds of electro-optical radiation sources, too, whose emission spectrum can be controlled to desired wavelengths. Moreover, any other known kinds of IR sources may be used in the invention; for sensors according to claim 6 the condition is that the source emits corresponding radiation to both sides. In cases where the IR source does not itself emit spectrally selected radiation, one may as disclosed in claim 5 employ infrared spectral filters or infrared dispersive elements for spectral selection of radiation for gas as well as reference measurement, the former being rather inexpensive and readily available and might be particularly useful for single gas sensors while the more costly dispersive elements would have applications in multigas sensors. In many cases it may be practical for the two IR sources to be adapted side by side, as shown in FIG. 2, but that is no necessity; like in FIG. 1 the IR sources may have mutually different positions as well as pathlengths relative to the detectors.

In FIG. 3 is shown a unit 32 according to claim 7. The unit comprises two IR sources 30 and 31 situated side by side, with spectrally selective IR filters 301 adapted to absorption in a gas to be measured mounted on each side of IR source 30 and IR filters 311 adapted to radiation that is not absorbed in any present gas mounted on each side of IR source 31. In a preferred make the IR filters may be arranged as windows in the unit 32, but other designs are possible, too. In order to avoid crosstalk between the two spectral channels, it may be advantageous to have a wall or screen 33 between the sources. By preference the unit 32 may be hermetically sealed and either evacuated or filled by inert and/or nonabsorbing gas. Electrical current is supplied to the IR sources from excitation unit 37 through terminals 34 and 35 into one or the other of the sources, with a common return through terminal 36 as shown or separately for each source. A unit such as depicted in FIG. 3 may easily be extended to comprise more IR sources with accompanying IR filters for selected gases. For each detector, the path lengths from the IR sources through the gas volume then will be close to equal. For sensors that are made according to FIG. 1, IR filters on one side of the unit may be left out.

In order to separate signals from the various IR sources from one another, the IR sources may be individually pulsated by single pulses at different times, as disclosed in claim 8. Signals from both detectors are then essentially time multiplexed, so that the position in time of any signal pulse uniquely identifies that IR source with its accompanying spectral radiation which is at any time illuminating each detector. Alternatively, the IR sources may be excited by continuous electrical pulse trains, each at its own pulse frequency; electronic frequency filtering then serves for each detector to separate between signals from one or the other of the IR sources. One source may also be continuously excited by constant currents while other IR sources are pulsed either by single pulses or continuous pulse sequences. By such technical means it is a simple matter to extract the various signals that are parts of the several independent measurements being performed by the sensor.

As is disclosed in claim 9, the optical means may consist of free propagation of radiation from the IR sources to the IR detectors, particularly when employing large area radiation-cooled IR sources; in other circumstances optical tubes with mirror-like internal walls and optical configurations comprising lenses and mirrors may be applicable. Any kinds of IR detectors may be used in the invention; in a preferred design as disclosed in claim 10 it may be advantageous to employ thermopile detectors because these have time responses well suited to radiation-cooled IR sources. As opposed to other makes of IR detectors, thermopiles have no 1/f noise and vary little with temperature, thus further contributing to improve both sensitivity and stability of sensors in accordance with the invention.

1. Method for infrared measurement of one or more gases comprising at least two sources for infrared radiation, electrical means adapted to excite said infrared radiation sources with electrical current, two infrared detectors D1 and D2 adapted to the detection of infrared radiation from said at least two infrared radiation sources, an open or closed volume being arranged between said infrared radiation sources and said infrared detectors and adapted to receive or contain gas to be measured, optical means arranged to guide infrared radiation from said infrared radiation sources through said open or closed volume to said infrared detectors, one or more elements for spectral selection of infrared radiation being arranged in the optical paths between said infrared radiation sources and said infrared detectors, and electronic means adapted to the registration, amplification, treatment and/or presentation of electrical signals from said infrared detectors when said infrared radiation sources are brought to illuminate said detectors through said open or closed volume, characterized in that
a gas a whose concentration is to be measured is brought into said open or closed volume,
for said gas a an infrared radiation source A is arranged to illuminate said infrared detectors D1 and D2 across optical path lengths Lila to detector D1 and L2a to detector D2 through said gas a where L1a is longer and by preference substantially longer than L2a,
at least one of said elements for spectral selection of infrared radiation is arranged between said infrared radiation source A and said infrared detectors D1 and D2 and is adapted for selection of spectral infrared radiation which may be absorbed by said gas a,
another infrared radiation source R is arranged to illuminate said infrared detectors by infrared radiation that is only weakly and by preference not absorbed by said gas a,
said infrared radiation sources A and R are being excited each at its own particular pattern in time M(A) and M(R), respectively, whereby pattern M(A) is adapted for radiation source A and pattern M(R) is adapted for radiation source R and where M(A) and M(R) are different from each other and from corresponding patterns for any and all other of said at least two infrared radiation sources, and in that
said electronic means for the registration, amplification, treatment and/or presentation of electrical signals are adapted to separate the electrical signals originating from each of said infrared detectors D1 and D2 on said particular patterns in time M(A) and M(R) when said detectors are being illuminated by said infrared radiation sources A and R through said gas a, to calculate the ratio FA between signals from detector D1 and detector D2 on said pattern M(A) and the corresponding ratio FR between signals from detector D1 and detector D2 on pattern M(R) and to use the ratio FA/FR as a measure of the concentration of said gas a.

2. Sensor for infrared measurement of one or more gases comprising at least two sources for infrared radiation, electrical means adapted to excite said infrared radiation sources with electrical current, two infrared detectors D1 and D2 adapted to the detection of infrared radiation from said at least two infrared radiation sources, an open or closed volume arranged between said infrared radiation sources and said infrared detectors and adapted to receive or contain gas to be measured, optical means arranged to guide infrared radiation from said infrared radiation sources through said open or closed volume to said infrared detectors, one or more elements for spectral selection of infrared radiation arranged in the optical paths between said infrared radiation sources and said infrared detectors, and electronic means adapted to the registration, amplification, treatment and/or presentation of electrical signals from said infrared detectors when said infrared radiation sources illuminate said detectors through said open or closed volume, characterized in that
for a gas a to be measured a selected infrared radiation source A is adapted to illuminate said infrared detectors D1 and D2 across optical path lengths L1a to detector D1 and L2a to detector D2 through said gas a where L1a is longer and by preference substantially longer than L2a and where both of said optical path lengths L1a and L2a are wholly inside said open or closed volume,
at least one of said elements for spectral selection of infrared radiation is arranged between said infrared radiation source A and said infrared detectors D1 and D2 and is adapted for selection of the spectral infrared radiation which may be absorbed by said gas a,
another infrared radiation source R is arranged to illuminate said infrared detectors by infrared radiation that is only weakly and by preference not absorbed by said gas a,
said infrared radiation sources A and R are adapted to be excited each at its own particular pattern in time M(A) and M(R), respectively, where pattern M(A) has been adapted for radiation source A and pattern M(R) adapted for radiation source R and where M(A) and M(R) are different from each other and from corresponding patterns for any and all other of said at least two infrared radiation sources, and in that
said electronic means for the registration, amplification, treatment and/or presentation of electrical signals are adapted to separate the electrical signals that originate from each of said infrared detectors D1 and D2 on said particular patterns in time M(A) and M(R) when said detectors are illuminated by said infrared radiation sources A and R through said gas a, to calculate the ratio FA between signals from detector D1 and detector D2 on said pattern M(A) and the corresponding ratio FR between signals from detector D1 and detector D2 on pattern M(R) and to use the ratio FA/FR as a measure of the concentration of said gas a.

3. Sensor according to claim 2, characterized in that at least one of said elements for spectral selection of infrared radiation is arranged between said infrared radiation source R and said infrared detectors and is adapted to the selection of spectral infrared radiation which is only weakly and by preference not absorbed by any present gas.

4. Sensor according to claim 2, characterized in that said infrared radiation sources comprise common thermally incandescent sources, radiation-cooled thermal sources and non-thermal sources in which said elements for spectral selection of infrared radiation are integral parts of the source's function.

5. Sensor according to claim 2, characterized in that said elements for spectral selection of infrared radiation comprise infrared spectral filters and infrared dispersive elements.

6. Sensor according to claim 2, characterized in that said infrared radiation sources are adapted to radiate from a front side and a rear side and in that said infrared detectors are arranged with one detector on the front side and one detector on the rear side of said infrared radiation sources.

7. Sensor according to claim 2, characterized in that said infrared radiation sources are adapted side by side in a special and by preference hermetically sealed unit and in that said spectrally selective elements comprise infrared spectral filters adapted at one or both sides of said unit.

8. Sensor according claim 2, characterized in that said patterns in time for the excitation of said infrared radiation sources are selected from the group comprising constant electrical current, single electrical pulses at chosen times and sequences of electrical pulses at different pulse frequencies.

9. Sensor according to claim 2, characterized in that said optical means comprise free propagation of radiation from said infrared radiation sources to said infrared detectors, infrared transmitting lenses, infrared reflective mirrors and infrared-optical tubes with mirror-like or diffuse internal walls.

10. Sensor according to claim 2, characterized in that said infrared detectors comprise thermopile detectors and any other known detectors for infrared radiation.

11. Sensor according to claim 2, characterized in that said two infrared detectors are arranged on the same side of said infrared radiation sources.

12. Sensor according to claim 8, characterized in that said two infrared detectors are arranged on the same side of said infrared radiation sources.

13. Sensor according to claim 12, characterized in that at least one of said elements for spectral selection of infrared radiation is arranged between said infrared radiation source R and said infrared detectors and is adapted to the selection of spectral infrared radiation which is only weakly and by preference not absorbed by any present gas.

14. Sensor according to claim 12, characterized in that said infrared radiation sources comprise common thermally incandescent sources, radiation-cooled thermal sources and non-thermal sources in which said elements for spectral selection of infrared radiation are integral parts of the source's function.

15. Sensor according to claim 12, characterized in that said optical means comprise free propagation of radiation from said infrared radiation sources to said infrared detectors, infrared transmitting lenses, infrared reflective mirrors and infrared-optical tubes with mirror-like or diffuse internal walls.

16. Sensor according to claim 8, characterized in that said infrared radiation sources are adapted to radiate from a front side and a rear side and in that said infrared detectors are arranged with one detector on the front side and one detector on the rear side of said infrared radiation sources.

17. Sensor according to claim 16, characterized in that at least one of said elements for spectral selection of infrared radiation is arranged between said infrared radiation source R and said infrared detectors and is adapted to the selection of spectral infrared radiation which is only weakly and by preference not absorbed by any present gas.

18. Sensor according to claim 16, characterized in that said infrared radiation sources comprise common thermally incandescent sources, radiation-cooled thermal sources and non-thermal sources in which said elements for spectral selection of infrared radiation are integral parts of the source's function.

19. Sensor according to claim 16, characterized in that said optical means comprise free propagation of radiation from said infrared radiation sources to said infrared detectors, infrared transmitting lenses, infrared reflective mirrors and infrared-optical tubes with mirror-like or diffuse internal walls.

20. Sensor according to claim 16, characterized in that said infrared radiation sources are adapted side by side in a special and by preference hermetically sealed unit and in that said spectrally selective elements comprise infrared spectral filters adapted at one or both sides of said unit.
